(19) United States
(12) Patent Application Publication
(10) Pub. No.: US 2009/0092699 A1
(43) Pub. Date: Apr. 9, 2009

(54) Injection Mold For Multi Insert Container

(75) Inventor: Jong-Sun Hong, Seoul (KR)

Correspondence Address: RANKIN, HILL & CLARK LLP, 925 EUCLID AVENUE, SUITE 700, CLEVELAND, OH, 44115-1405, US

(73) Assignee: SIERRA M CO., LTD., Kyunggi-do (KR)

(21) Appl. No.: 11/958,444

(22) Filed: Dec. 18, 2007

(30) Foreign Application Priority Data
Oct. 5, 2007 (KR) 20-2007-0016250

(51) Int. Cl. B29C 45/14

(52) U.S. Cl. 425/134

(57) ABSTRACT

An injection mold for a multi insert container is provided, which includes a plurality of cavities, formed in order between a fixed mold and a movable mold that constitute an injection mold, for performing an insert molding of the multi insert container by stages, wherein an insert injection molding is performed simultaneously with a successive supply of molded products to the respective cavities. According to the injection mold, since a multi insert molding is performed through movement of the molded products by stages in the single mold, the workability is improved in comparison to a conventional insert molding method that uses a plurality of molds, and the molding conditions of the molded products are kept uniform to achieve a good quality of the molded products.

### CROSS-REFERENCE TO RELATED APPLICATION

This application is based on and claims priority from Korean Utility Model Application No. 20-2007-0016250, filed on Oct. 5, 2007, in the Korean Intellectual Property Office, the disclosure of which is incorporated herein in its entirety by reference.

### BACKGROUND OF THE INVENTION

1. Field of the invention

The present invention relates to an injection mold for a multi insert container, and more particularly, to an injection mold for a multi insert container, in which molding parts are intensively formed in a single mold, and a multi insert molding is performed through movement of molded products by stages in the single mold, so that the workability is improved and the molding conditions of the molded products are kept uniform to achieve a good quality of the molded products.

2. Description of the Prior Art

Generally, a cosmetic container made of synthetic resin is manufactured by injection molding.

If the cosmetic container is thick, the molded product may become inferior during the injection molding, and the molding time is lengthened due to the cooling of the molded product, resulting in deterioration of the productivity.

In order to solve this problem that occurs in the case of molding a thick container, a multi insert molding method is performed in manufacturing the container.

That is, the thick container is not molded at a single time, but is molded through a multistage insert molding to secure a desired thickness of the container.

According to this multi insert molding method by stages, a plurality of molds is required to increase the manufacturing cost, and the molding work is successively performed through the plurality of molds to lower the productivity.

In addition, during the successive molding through the plurality of molds, it is difficult to keep the molding conditions of the respective molds uniform, and thus the workability and quality of the molded products deteriorate.

### SUMMARY OF THE INVENTION

Accordingly, the present invention has been made to solve the above-mentioned problems occurring in the prior art while advantages achieved by the prior art are maintained intact.

One object of the present invention is to provide an injection mold for a multi insert container, in which molding parts are intensively formed in a single mold, and a multi insert molding is performed through movement of molded products by stages in the single mold, so that the workability is improved and the molding conditions of the molded products are kept uniform to achieve a good quality of the molded products.

In order to accomplish the object, in one aspect of the present invention, there is provided an injection mold for a multi insert container, which includes a plurality of cavities, formed in order, e.g., horizontally or vertically, between a fixed mold and a movable mold that constitute an injection mold, for performing an insert molding of the multi insert container by stages, wherein an insert injection molding is performed simultaneously with a successive supply of molded products to the respective cavities.

### BRIEF DESCRIPTION OF THE DRAWINGS

The above and other objects, features and advantages of the present invention will be more apparent from the following detailed description taken in conjunction with the accompanying drawings, in which:

FIG. 1 is a sectional view explaining a process of molding a multi insert container by stages according to the present invention;

FIG. 2 is a front sectional view illustrating an example of an injection mold according to the present invention;

FIG. 3 is a plan view illustrating an example of an injection mold according to the present invention;

FIG. 4 is an enlarged view of main parts of the injection mold in FIG. 3; and

FIG. 5 is a view illustrating an operation state of the injection mold in FIG. 4.

### DETAILED DESCRIPTION OF THE PREFERRED EMBODIMENTS

Hereinafter, preferred embodiments of the present invention will be described with reference to the accompanying drawings. The matters defined in the description, such as the detailed construction and elements, are nothing but specific details provided to assist those of ordinary skill in the art in a comprehensive understanding of the invention, and thus the present invention is not limited thereto.

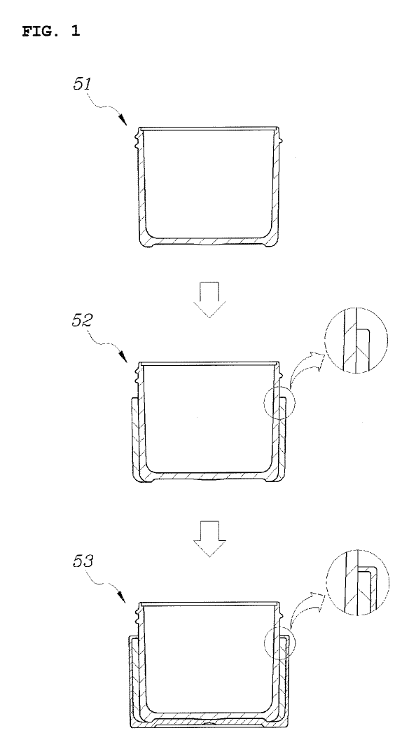

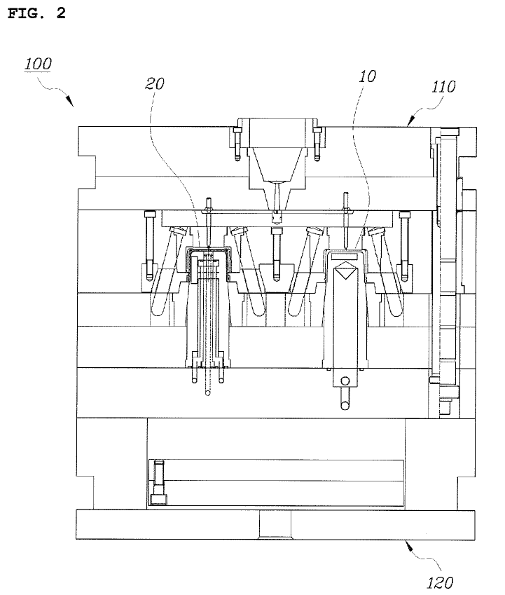

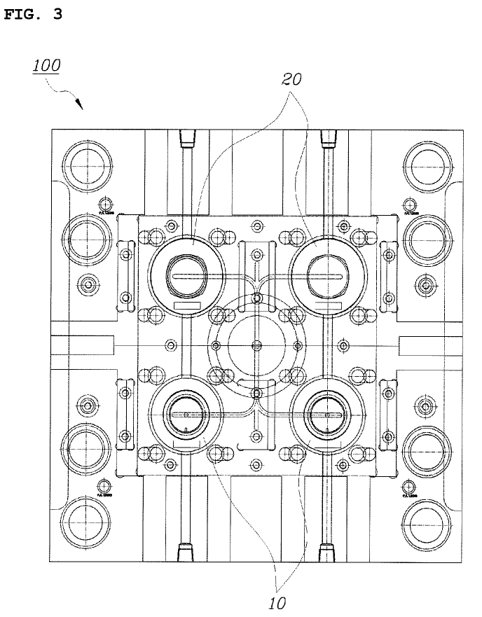

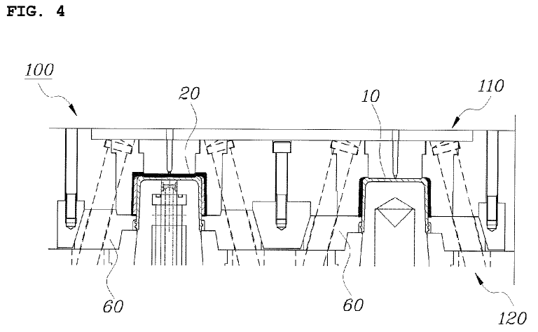

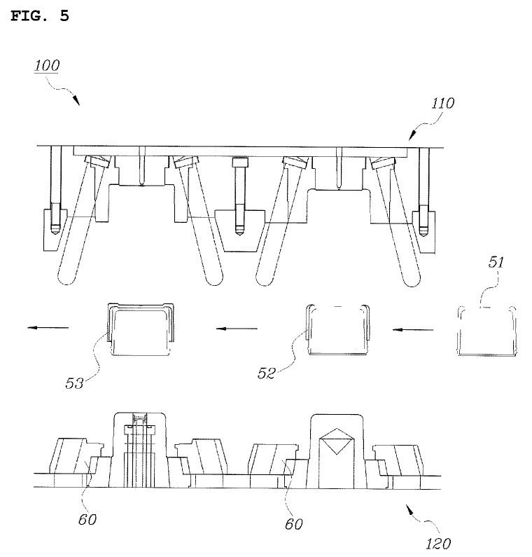

The construction and operation of an injection mold for a multi insert container according to an embodiment of the present invention will now be described in detail with reference to FIGS. 1 to 5.

Between a fixed mold 110 and a movable mold 120 that constitute an injection mold 100, a plurality of cavities 10 and 20 is formed in order, e.g., horizontally or vertically, to perform an insert molding of a multi insert container by stages, and an insert injection molding of the container is performed as the molded products are successively supplied to the cavities 10 and 20.

The cavities 10 and 20 may be provided in different forms according to the frequency of insert molding of the multi insert container.

As illustrated in FIG. 1, a firstly molded product 51 is insert-molded through the first-stage cavity 10 to produce a secondarily molded product 52, and the secondarily molded product 52 is then insert-molded through the second-stage cavity 20 to produce a thirdly molded product 53 that is a finished product.

In this case, although it is possible to intensively form a cavity for molding the firstly molded product 51 in the single mold and to perform the insert molding of the product by stages, it is preferable to mold the firstly molded product in a separate manner in order to form a spiral part for engaging with a cap that is formed on the firstly molded product.

The supply of the firstly molded product 51 to the first-stage cavity 10, the supply of the secondary molded product 52 molded through the first-stage cavity 10 to the second-stage cavity 20, and the supply of the thirdly molded product 53 molded through the second-stage cavity 20 are performed by typical robots or carriers in a state that the mold is open.

The reference numeral “60” denotes a slide block of the mold.

The operation of the injection mold for a multi insert container as constructed above according to an embodiment of the present invention will now be described.

In the present invention, a multi insert container is insert-molded by stages in a single injection mold 100.

With reference to FIGS. 1, 4 and 5, the molding of the multi insert container by stages will be described in detail.

First, the firstly molded product 51 is formed through a separate injection molding process.

The reason why the firstly molded product is formed in a separate manner is to form a spiral part for engaging with a cap on the firstly molded product.

The firstly molded product 51 is supplied to the first-stage cavity 10 in a state that the fixed mold 110 and the movable mold 120 of the injection mold 100 are opened.

The supply of the molded products is performed through typical robots or carriers.

The firstly molded product 51 supplied to the first-stage cavity 10 is molded through the first insert molding process to produce the secondarily molded product 52.

The secondarily molded product 52 molded in the first-stage cavity 10 is then supplied to the second-stage cavity 20 through the typical robots or carriers in a state that the fixed mold 110 and the movable mold 120 of the injection mold 100 are open.

At the same time, a new firstly molded product 51 is successively supplied to the first-stage cavity 10 to be molded.

The secondarily molded product 52 supplied to the second-stage cavity 20 is molded through the second insert molding process to produce the third molded product 52 that is the finished product.

The finished product molded in the second-stage cavity 20 is then discharged to an outside through the typical robots or carriers in a state that the fixed mold 110 and the movable mold 120 of the injection mold 100 are open.

At the same time, the secondarily molded product newly molded in the first-stage cavity 10 is supplied to the second-stage cavity 20, and another new firstly molded product is supplied to the first-stage cavity 10, so that they are simultaneously molded.

Accordingly, the molded products 51 are successively supplied to the first-stage cavity 10 and the second-stage cavity 20 formed in the same mold 100, and then simultaneously molded to successively produce the multi insert containers.

Since the rest of the injection molding technology is well known in the art, the detailed description thereof will be omitted.

In the injection mold according to the present invention, the detailed structure of the mold may be diversely modified, and the number of cavities may correspond to the frequency of the insert molding.

As described above, according to the injection mold for a multi insert container according to the present invention, a plurality of cavities for performing an insert molding of a multi insert container by stages are intensively formed in a single mold, and a multi insert molding is performed through movement of the molded products by stages in the single mold. Accordingly, the workability is improved in comparison to the conventional insert molding that uses a plurality of molds, and the molding conditions of the molded products are kept uniform to achieve a good quality of the molded products.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. An injection mold for molding a multi insert container, comprising a plurality of cavities, formed in order between a fixed mold and a movable mold that constitute an injection mold, for performing an insert molding of the multi insert container by stages, wherein an insert injection molding is performed simultaneously with a successive supply of molded products to the respective cavities.
